(19) United States
(12) Patent Application Publication
(10) Pub. No.: US 2011/0079106 A1
(43) Pub. Date: Apr. 7, 2011

(54) POWER GENERATING SYSTEM AND APPARATUS

(76) Inventors: Shih Chen LIU, Tu Cheng (TW); Tai Tsung LIU, Tu Cheng (TW)

(21) Appl. No.: 12/574,942

(22) Filed: Oct. 7, 2009

(51) Int. Cl. F16F 15/30

(52) U.S. Cl. 74/572.11

(57) ABSTRACT

A power generating system utilizes rotational inertia forces of a pair of fly wheels fitted with friction-type driving devices to keep the fly wheels accelerating and rotating and to output power to do work. Totally through a first transmission device and a driving device linked with the first transmission device, an output of a first fly wheel drives a second fly wheel to rotate and amplifies a torque of the second fly wheel to do work. The second fly wheel also feeds back part of an output moment to the first fly wheel through a second transmission device and a first driving device linked with the second transmission device to keep the first fly wheel rotating by an inertia force. A diameter and weight of the second fly wheel are much greater than those of the first fly wheel. To increase output torques of the fly wheels, the fly wheels are preferably added with centrifugal weighting units, such that when reaching to designated rotation speeds or above, the fly wheels can move outward by centrifugal forces to increase the inertia forces and the torques.

### BACKGROUND OF THE INVENTION

a) Field of the Invention

The present invention relates to a power generating system, and more particularly to a power generating system and machine which utilizes a cross support of a moment of inertia of a pair of fly wheels fitted with an actuator to maintain the fly wheels accelerating and rotating and to generate a power output to do work from the endmost fly wheel.

b) Description of the Prior Art

Until now, a well known conventional power generating machine includes an electric motor which is driven by electric energy, an internal combustion engine and an external combustion engine which utilize combustion energy of fuels, a pneumatic motor which utilizes air pressure, a hydraulic motor which utilizes hydraulic pressure, a water mill which utilizes water power and a wind mill which utilizes wind power. In the aforementioned power generating machines or apparatuses, other than those utilize the water power and wind power in nature as an energy source to drive the machines or apparatuses to operate, all other apparatuses must keep on consuming a lot of energy, such as electricity, oil, coal or other fuel, during operation. Although the power generating machines or apparatuses which utilize the water power or wind power do not waste the aforementioned energy source, they are limited by landforms, positions and weather. In addition, they take up a very large space and are provided with very expensive equipment. As a result, their applications are also quite limited.

Recently, there are apparatuses which utilize solar energy or energy from tides or ocean waves to generate electricity. Yet, these apparatuses are also limited by landforms and weather, take up a very large space and are provided with expensive equipment.

Besides, in the aforementioned power generating machines, those utilizing oil or coal can even cause an issue of public hazard like air pollution or global warming.

### SUMMARY OF THE INVENTION

Accordingly, it is actually expected by related vendors to provide a power generating machine which consumes less energy, is provided with cheap equipment, is not limited by landforms, weather or space, is easy to be controlled and can be applied broadly.

The primary object of the present invention is to provide a power generating system which is developed to eliminate the aforementioned issues. The power generating system utilizes a cross support of a force difference of rotational inertias produced by a large and a small fly wheels fitted and complemented with transmission and driving means, so as to maintain the fly wheels accelerating and operating, thereby outputting power to do work.

A second object of the present invention is to provide a power generating machine which only consumes very little external starting power to drive a large and a small fly wheels to rotate. After each fly wheel rotates to a desired rotation speed or above, at a same time when inertia power resulted from the large fly wheel, a moment of which is amplified through a transmission device and outputted through an output shaft to do work, part of the output is fed back to a driving device of the small fly wheel to generate auxiliary driving power. By this cross support, the fly wheels can keep on self-operating and only when the output power and the rotation speeds reduce to designated values by consumption that the external starting power can be applied again, so that external driving is stopped after returning to the normal operation.

A third object of the present invention is to provide a power generating machine which includes at least a small and a large fly wheels, with that after an output of at least one fly wheel at a front end is amplified by at least one transmission device, the output is inputted to the endmost fly wheel as power and that this endmost fly wheel will feed back part of the output to the front end fly wheel to maintain the operation of the entire system.

A fourth object of the present invention is to provide a power generating machine wherein fly wheels are provided with a centrifugal weighting unit, such that when rotation speeds of the fly wheels reach to designated rotation speeds or above, the fly wheels can move outward by centrifugal forces, thereby increasing output torques.

A fifth object of the present invention is to provide a power generating machine, wherein a friction wheel transmission method is used by a driving wheel which facilitates a fly wheel to keep on operating and accelerating, with that a contact point of the driving wheel with the fly wheel is at a position where a central axis connecting the fly wheel with the driving wheel is deflected toward a rotation direction by an angle, with respect to a horizontal center line.

A sixth object of the present invention is to provide a power generating machine which is provided with simple structures and devices, is suitable for mass production, can save a lot of energy, does not have an issue of public hazard and can be applied broadly.

According to the aforementioned objects, the power generating system and machine provided basically utilize differences of a diameter and mass between a large and a small fly wheels as well as a power difference which is increased through transmission devices to cross drive, thereby keeping the two fly wheels to rotate continuously and preserving inertia energy. In addition, power is outputted through an output shaft of the large fly wheel, whereas part of the power which is fed back to the small fly wheel is very little that consumption is limited. As a result, the system can maintain operating in a very long time and this system is apparently a breaking-through invention that has never been seen and may bring to the world revolutionary and energy-saving alternative power.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a power generating system of the present invention.

FIG. 2 shows a schematic view of an embodiment of an apparatus which is constituted according to a power generating system of the present invention.

FIG. 3 shows a side view of the apparatus of FIG. 1.

FIG. 4A shows a front view of a deformed embodiment of a fly wheel of the present invention.

FIG. 4B shows a side view of a deformed embodiment of a fly wheel of the present invention.

FIG. 5 shows a schematic view of an embodiment of a fly wheel which is provided with a centrifugal weighting unit.

FIG. 6 shows a cutaway view of a friction plate utilized by a hub of a fly wheel.

FIG. 7 shows a block diagram of another embodiment of a power generating system of the present invention.

### DETAILED DESCRIPTION OF THE PREFERRED EMBODIMENTS

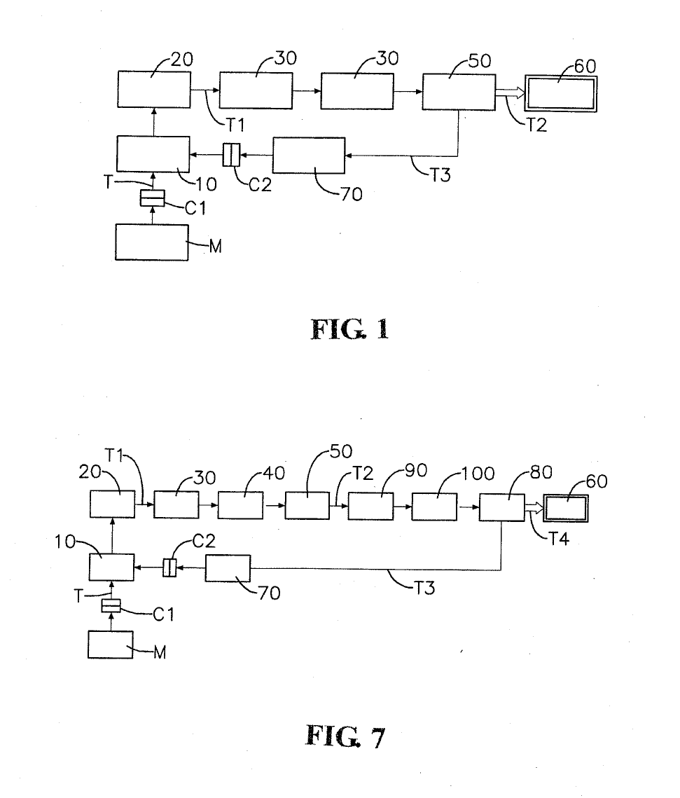

Referring to FIG. 1, it shows a block diagram of a power generating system of the present invention. The system comprises primarily a starting motor M, a first driving device 10, a first fly wheel 20, a first transmission device 30, a second driving device 40, a second fly wheel 50, a loading member 60 and a second transmission device 70. Herein, the driving devices 10, 20 are also called actuators.

In this system, the motor M is separably connected through a proper clutch means C1 with the first driving device 10 which is used to drive the first fly wheel 20. Therefore, an output moment T generated by the motor M drives the first fly wheel 20 to rotate through the clutch C1 and the first driving device 10. After the fly wheel 20 rotates, the output moment T is transmitted through the first transmission device 30 to the second driving device 40 which is used to drive the second fly wheel 50, so as to drive the second fly wheel 50 to rotate. As a diameter of the second fly wheel 50 is larger than that of the first fly wheel 20, a moment of inertia generated is also lager than that of the first fly wheel 20. A primary output moment T2 of this second fly wheel 50 is transmitted to the loading member 60 to do work; whereas, the loading member 60 can be a transmission device of a machine tool, a pump, a generator or other mechanical device. The second fly wheel 50 also separates small part of the moment T3 which is fed back to the first driving device 10 through the second transmission device 70, so as to keep the first fly wheel 20 rotating. In this system, between the motor M and the first driving device 10, as well as between the first driving device 10 and the second transmission device 70, are provided respectively with the clutches C1, C2 which are used when starting, as described hereinafter.

When the power generating system starts, the motor M is first turned on, allowing the output moment T to drive the first driving device 10 to rotate through the clutch C1. Hence, the first driving device 10 will drive the first fly wheel 20 to rotate. When the first fly wheel 20 rotates, an output moment T1 thereof will be transmitted through the first transmission device 30 to drive the second driving device 40 to rotate and therefore, the second driving device 40 will drive the second fly wheel 50 to rotate. When the second fly wheel 50 rotates, large part of the output moment T2 is outputted to the loading member 60 to do work. On the other hand, the second fly wheel 50 also separates part of the output moment T3 which is transmitted through the second transmission device 70 to be fed back to the first driving device 10, so as to keep driving the first fly wheel 20 to rotate. After the two fly wheels 20, 50 rotate normally and reach to required rotation speeds and moments of inertia, the motor M will leave the system (that is, escaping from the first driving device 10) by the clutch means C1 and a power source is turned off to stop the motor M temporarily. At this time, the fly wheels 20, 50 will continue rotating by inertia forces of their own but are gradually decelerated as energy is consumed to do work. Yet, as part of the large moment of inertial outputted by the large fly wheel (the second fly wheel) 50 is released to the first driving device 10 to generate a driving force to keep the small fly wheel (the first fly wheel) 20 rotating to preserve the inertia force, the fly wheel 20 can continue rotating and the output moment and the rotation speed are amplified through the first transmission device 30 and then outputted to the second driving device 40 to make the large fly wheel 50 continue operating at the desired rotation speed. In addition, the large inertia power, which is larger than that of the fly wheel 20 by several times (depending on ratios of diameters, weights and rotation speeds of the two fly wheels 20, 50) and is accumulated in the large diameter, is used to drive the loading member 60 to do work. In the aforementioned system, there is a principle that under the same rotation speed, the moment of inertia generated by the second fly wheel 50 should be at least more than one time that of the first fly wheel 20. In other words, the diameter and mass of the second fly wheel 50 should be at least two times those of the first fly wheel 20.

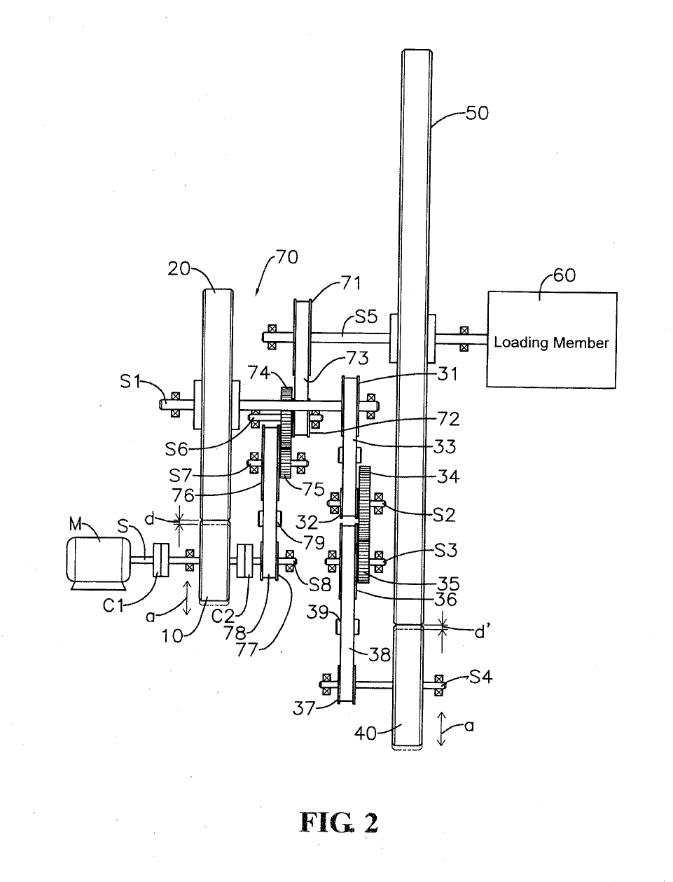

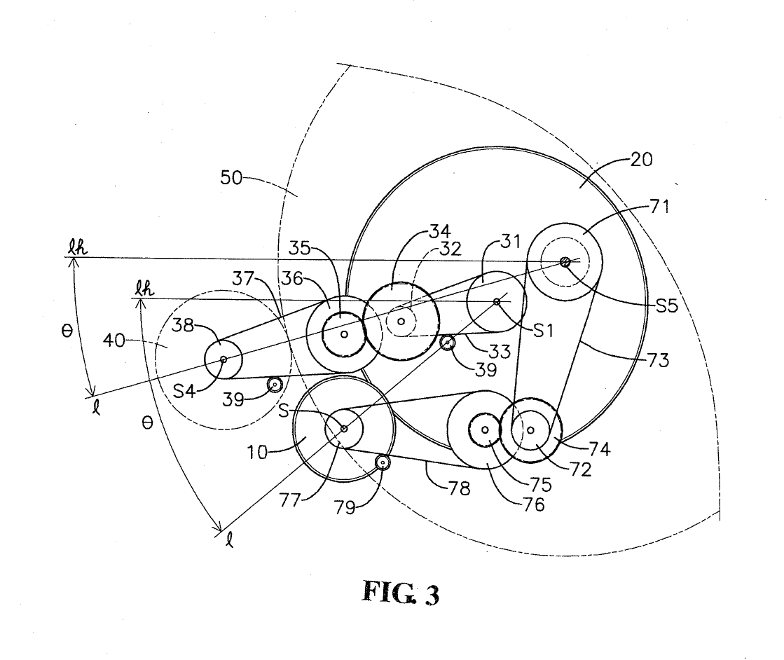

Referring to FIG. 2 and FIG. 3, it shows schematic views of a specific embodiment of a power generating apparatus of the present invention. This apparatus is provided with the motor M, a shaft S of which is connected through the clutch C1 with the first driving wheel 10 acting as a fly wheel driving device. This driving wheel 10 is in touch with the first fly wheel 20 and drives the fly wheel 20 to rotate by a friction force. An end of a shaft S1 of the first fly wheel 20 is provided with the first transmission device 30 which transmits a torque to the second driving wheel 40. In the present embodiment, the first transmission device 30 uses a complex transmission system of pulleys and gears, including a master pulley 31 which is driven by the rotation shaft S1, a slave pulley 32 which is fixed on a shaft S2, a transmission belt 33 which is hung between the pulleys 31, 32, a gear 34 which is fixed on the same shaft S2, a gear 35 which is fixed on a shaft S3 and is gnawed with the gear 34, a master pulley 36 which is fixed on the shaft S3, a slave pulley 37 which is fixed on a shaft S4 of the aforementioned second driving wheel 40 and a transmission belt 38 which is hung between the two pulleys 36, 37. The second driving wheel 40 is in touch with the second fly wheel 50 and drives the second fly wheel 50 to rotate by a friction force.

An end of a rotation shaft S5 of the second fly wheel 50 is connected to the loading member 60 to do work; whereas, the loading member 60 can be a transmission device of a machine tool, a pump, a generator or a driving device of other machine, depending on a purpose of use. In addition, the loading member 60 can be directly connected with the shaft S5 or can be connected with the shaft S5 through a proper transmission device (not shown in the drawings). On the other hand, the other end of the rotation shaft S5 of the second fly wheel 50 is provided with another second transmission device 70 which feeds back part of the output moment of the second fly wheel 50 to the aforementioned first driving wheel 10. In the present embodiment, the second transmission device 70 uses a complex transmission system of pulleys and gears, constituted by a master pulley 71 which is fixed on the rotation shaft S5, a slave pulley 72 which is fixed on a shaft S6, a transmission belt 73 which is hung between the pulleys 71, 72, a gear 74 which is fixed on the shaft S6, a gear 75 which is fixed on a shaft S7 to be gnawed with the gear 74, a pulley 76 which is fixed on the shaft S7, a shaft S8 which is fixed on the aforementioned first driving wheel 10, a slave pulley 77 on a shaft which is connected with the output shaft S of the motor M and a transmission belt 78 which is hung between the pulleys 76, 77. Between the motor M and the first driving wheel 10, as well as on each shaft S, S8 between the first driving wheel 10 and the pulley 77, are provided respectively with the clutches C1, C2 which can be escaped and engaged when necessary.

Furthermore, corresponding to the first fly wheel 20 and the second fly wheel 50 respectively, the first driving wheel 10 and the second driving wheel 40 can move within positions d, d′ without touching with and bonding by pressure the fly wheels 20, 50 along arrows a as shown in FIG. 2, in order to adjust speeds and outputs of the fly wheels 20, 50. Regarding to means (not shown in the drawing) which allow the first driving wheel 10 (along with the shaft S8 and the pulley 77) and the second driving wheel 40 (along with the shaft S4 and the pulley 37) to move radially with respect to the corresponding fly wheels 20, 50, no further drawing and description are give here to simplify and make clear the drawings of the present invention, as there are plenty of devices or means applied by the existing technology. As the distances of movement d, d′ of the first driving wheel 10 with respect to the first fly wheel 20 and of the second driving wheel 40 with respect to the second fly wheel 50 are only a few millimeters, to cope with looseness of the transmission belts 38, 78 associated with a change of these distances d, d′, a midway of the transmission belt 38 or 78 is provided respectively with a belt tension roller 39 or 79 to adjust the tension of the belt.

In the present embodiment, the first and second transmission devices 30, 70 use primarily, but not restricted to, the complex transmission devices of the belts and pulleys fitted with the gears. Any person who is familiar with this technology can apparently understand that a transmission device can also use a proper transmission device of a full gear type, a sprocket wheel type, a gearbox transmission bar type or a combination type. However, disregarding which transmission device is chosen to use, the transmission device should allow rotation speeds of the driving wheels 10, 40 to be higher than those of the corresponding fly wheels 20, 50, so as to keep the fly wheels 20, 40 rotating. In the present embodiment, the transmission devices 30, 70 are configured, but not restricted to, between the two fly wheels 20, 50. Apparently, any one or both of the transmission devices 30, 70 can be also arranged outside of the corresponding fly wheel. Besides, the arrangement of the transmission devices 30, 70 is not limited to that shown in FIG. 3 which only describes a transmission condition of the devices, and in fact, all kinds of proper arrangements can be made, as long as that the operation of the fly wheel can be transmitted to each driving wheel as required. In addition, it prefers to that contact positions of the driving wheel 10 with the fly wheel 20 and of the driving wheel 40 with the fly wheel 50 are as shown in FIG. 3, wherein connection lines l joining centers of axes of the driving wheels 10, 40 with centers of axes of the corresponding fly wheels 20, 50 are at any positions within angles θ by which horizontal lines lh passing through the centers of axes of the fly wheels 20, 50 are tilted along rotation directions of the fly wheels 20, 50. The angles θ are between 0° and 45° but are preferably between 10° and 30°.

Next, the operation condition of the aforementioned power generating apparatus is described as below.

First of all, before starting the motor M, the clutch C1 is engaged while the clutch C2 is escaped. Under this state, the motor M is started and the motor M will drive the first fly wheel 20 through the first driving wheel 10 to rotate. When this fly wheel 20 rotates, the second fly wheel 50 is driven to rotate orderly through the pulley 31, the belt 33, the pulley 32, the gear 33, the gear 34, the pulley 35, the belt 37, the pulley 36 and the second driving wheel 40 of the first transmission device 30. After the second fly wheel 50 rotates, a rotation force is inputted to the loading member 60 to do work. On the other hand, the other end of the shaft S5 of the second fly wheel 50 will drive the second transmission device 70 to rotate with a sequence of transmission of the pulley 71, the belt 73, the pulley 72, the gear 74, the gear 75, the pulley 76, the belt 78, the pulley 77 and the first driving wheel 10, to drive the first fly wheel 20 to rotate.

When the entire system operates successfully and the rotation speeds of the fly wheels 20, 50 reach to the designated values or above, the fly wheels 20, 30 can continue rotating by the inertias. At this time, after the clutch C1 is escaped and the other clutch C2 is engaged, the motor M stops operating and the first driving wheel 10 is driven to rotate by a torque which is fed back through the second transmission device 70 from the second fly wheel 50, rather than being driven by the motor M. Accordingly, the first driving wheel 10 will continue to drive the first fly wheel 20 to keep rotating. The engagement and escape of the aforementioned clutches C1, C2 and the stop and start of the motor M can be accomplished by control with a microprocessor or a computer, which belongs to the prior art and thus is not described further.

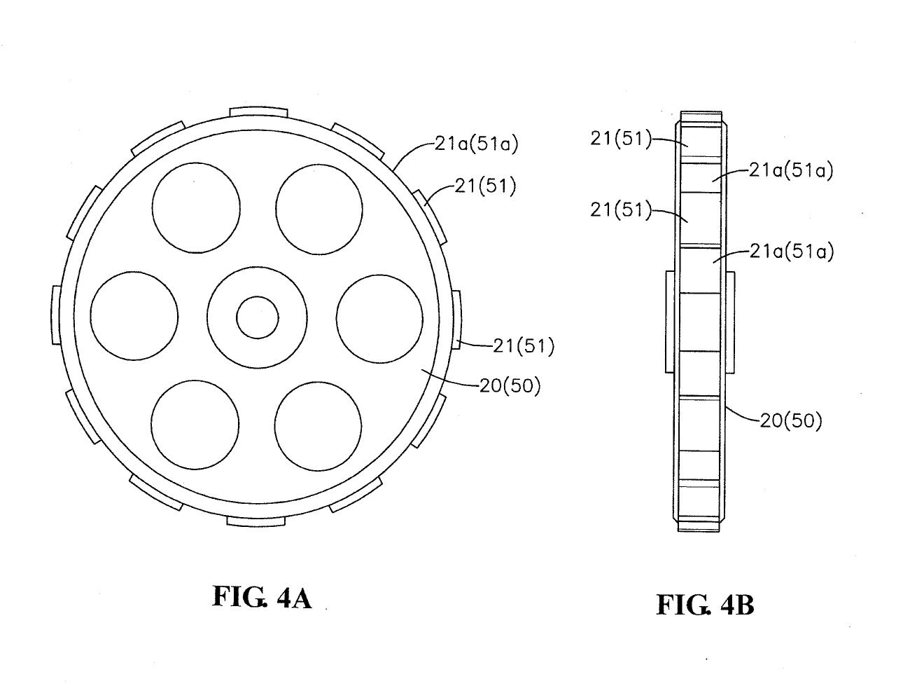

When the system operates normally and the two fly wheels 20, 50 rotate by the inertias, as long as the corresponding driving wheels 10, 40 intermittently toggle the fly wheels 20, 50 gently, the fly wheels 20, 50 can keep on rotating by the inertias. Therefore, the driving wheels 10, 40 do not need to touch frequently and completely with the corresponding fly wheels 20, 50. Hence, at least circumferential surfaces where the fly wheels 20, 50 touch with the driving wheels 10, 40 can constitute plural non-continuous friction surfaces or friction plates 21, 51, as shown in FIG. 4. It is preferable that the friction plates 21, 51 are provided with a same size and are configured in an equal space, with that grooves 21a, 51a are formed between neighboring sections of the friction surfaces or between neighboring friction plates 21, 51. As a result, when rotating, these grooves 21a, 51a will not touch with the circumferential surfaces of the driving wheels 10, 40. In another embodiment, although not shown in the drawings, the circumferential surfaces where the driving wheels 10, 40 touch with the fly wheels 20, 50 can also form the aforementioned non-continuous friction surfaces.

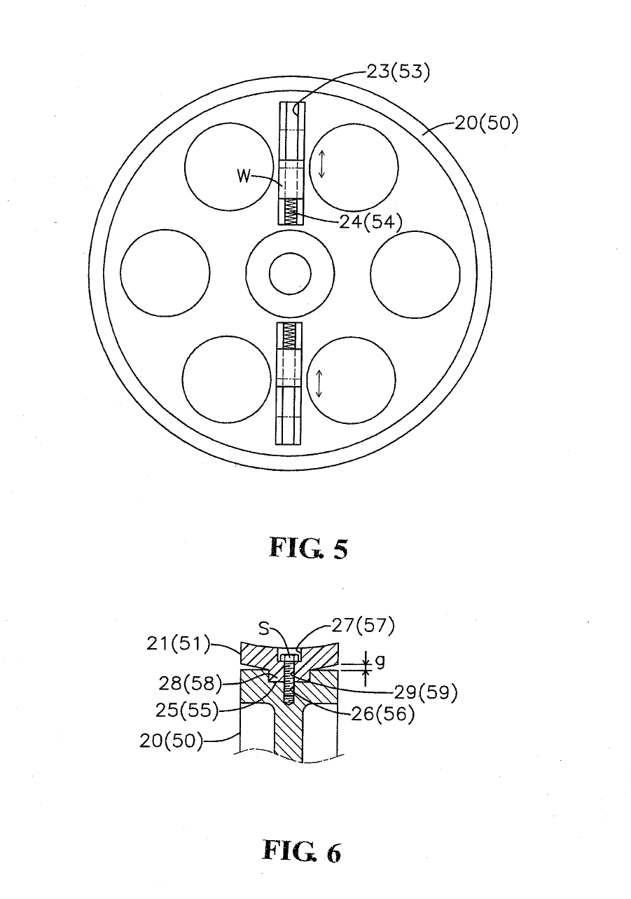

To allow the torques of the fly wheels 20, 50 to increase in proportion to the rotation speeds, arms 22, 52 of the fly wheels 20, 50 can be provided with at least one pair of diametrically symmetric centrifugal weighting units W, as shown in FIG. 5. This centrifugal weighting unit W can move freely in a radial direction following a centrifugal force which is generated when the fly wheel 20 or 50 rotates. In the first embodiment, the weighting unit W can slide freely in a radial direction by a resetting spring 24 or 54 along a guide 23 or 53 which is provided in the arm 22 or 52. When the fly wheel is at rest, the spring 24 or 54 can pull back the weighting unit W to an end of the guide 23 or 53 close to the shaft. In the description of this embodiment, the first and second fly wheels 20, 50 are all provided with the centrifugal weighting unit W and related devices. However, it also applies to install this centrifugal device in any one fly wheel.

As shown in FIG. 6, to allow the friction surfaces of the fly wheels 20, 50 to be replaceable after abrasion and also to provide better conformance and pressure bonding effect when the friction surfaces are bonded with pressure by the driving wheels 10, 40, the friction plates 21, 51 which form the non-continuous friction surfaces are made by abrasion resistant, hard and elastic synthetic resin and are fixed in a dismountable way in screw holes 26, 56 of annular grooves 25, 55 on the circumferential surfaces of the fly wheels by proper fixing means, such as screws S. To achieve the aforementioned object, the friction plate 21 or 51 is formed with an arc-shaped plate corresponding to an outer circumference of the fly wheel 20 or 50, a center on the arc-shaped plate is provided with a groove 27 or 57 which is extended circumferentially and a lower side of the arc-shaped plate is provided with a downward projection portion 28 or 58 which can be latched into the aforementioned annular groove 25 or 55. An interior of the groove 27 or 57 is provided with a through-hole 29 or 59 into which the screw S is transfixed to be rotated into the screw hole 26 or 56 of the annular groove 25 or 55, thereby fixing the friction plate 21 or 51 at the outer circumferential surface of the fly wheel 20 or 50. An outer surface where the friction plate 21 or 51 touches with driving wheel 10 or 40 can be a flat surface, but is preferably formed with an arc-shaped surface or tilted surface which is concaved down a little toward the central groove, as shown in the drawing. In addition, a tiny gap g is left between a bottom surface at two sides of the projection portion 28 or 58 of the friction plate 21 or 51 and the outer circumferential surface of the fly wheel 20 or 50, to tolerate some elastic reaction force when the driving wheel 10 or 40 bonds by pressure with the friction plate 21 or 51, thereby facilitating the driving wheel 10 or 40 to adjust the pressure bonding force to the fly wheel 20 or 50.

FIG. 7 shows another embodiment of a power generating system of the present invention. In the aforementioned embodiment, the power generating apparatus is constituted by a pair of parallel fly wheels 20, 50 and the related transmission devices. However, it is apparently that an output side of the second fly wheel 50 can be also added with a third fly wheel 80, a diameter of which is larger than that of the second fly wheel 50. The second fly wheel 50 transmits an output moment to the third fly wheel 80 through a third transmission device 90 and a third driving wheel 100 and the third fly wheel 80 generates a larger output moment to drive the loading member 60 to do work, with part of the output moment being fed back to the first fly wheel 20 through the transmission device 70 and the driving wheel 10. In another embodiment which is shown in the drawing, the third fly wheel 80 feeds back part of the output moment to the first fly wheel 20 and if it is necessary, a fourth fly wheel can be added again and arranged according to the aforementioned principle.

Collaterally describing, the system and apparatus of the present invention is not a perpetual machine, but a mechanical power device which saves energy. After the entire system, which comprises primarily a pair of fly wheels, is driven by an external driving source, such as a motor, and when the system is able to maintain operating by inertia energy of the fly wheels, the motor stops. On the other hand, when the system is insufficient to maintain operating by consuming energy to do work, the motor is used again to assist driving to maintain the normal operation of the system. As a result, the motor is only started when necessary and hence, energy can be saved.

Due to the aforementioned structures, the present invention provides a power generating machine which is able to save energy, does not have pollution, has simple structures, can be manufactured easily and is provided with a cheap cost. Therefore, industrial applications can be expected.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A power generating system comprising:
a driving source;
a first transmission device which is driven to rotate by the driving source and is released through a clutch;
a first fly wheel which is driven to rotate by the first transmission device;
a second driving device which rotates through transmission of the first transmission device from the first fly wheel; and
a second fly wheel, which is driven to rotate by the second driving device, an output of which provides primarily to a loading member to do work, with that part of the output is fed back to the first driving device through the second transmission device to take over the driving source for driving and maintaining inertia rotation of the first fly wheel;
when the entire system is full of inertia energy and is able to maintain a required operation state, the driving source being ceased to supply driving power and instead a force which is fed back from the second fly wheel being used to keep the first fly wheel rotating and to do work; when output energy of the second fly wheel decreases to a designated value or below, the driving source being started again to restore the system to the original operation state and then being escaped from the system, forming a repeated cycle of operation.

2. A power generating apparatus comprising:
a motor which serves as a driving source;
a first driving wheel which is driven by the motor to rotate through a clutch;
a first fly wheel which is driven by the first driving wheel to rotate;
a second driving wheel which rotates through transmission of a first transmission device from the first fly wheel; and
a second fly wheel which is driven by the second driving wheel to rotate, outputs power from a rotation shaft to a loading member to do work and at a same time, outputs small part of the power to feed back to the first driving wheel through a second transmission device, so as to drive the first fly wheel to rotate.

3. The power generating apparatus according to claim 2, wherein a diameter and mass of the second fly wheel are at least two times a diameter and mass of the first fly wheel.

4. The power generating apparatus according to claim 2, wherein the first transmission device amplifies an output moment and a rotation speed of the first fly wheel and then inputs to the second driving wheel to drive the second fly wheel.

5. The power generating apparatus according to claim 2, wherein the second transmission device amplifies part of an output moment and a rotation speed of the second fly wheel and then inputs to the first driving wheel to drive the first fly wheel.

6. The power generating apparatus according to claim 2, wherein the first driving wheel drives the first fly wheel and the second driving wheel drives the second fly wheel by friction contact.

7. The power generating apparatus according to claim 6, wherein friction contact surfaces of the first fly wheel and second fly wheel with the corresponding first driving wheel and second driving wheel are formed with continuous friction surfaces along an outer circumference of each fly wheel.

8. The power generating apparatus according to claim 6, wherein friction contact surfaces of the first fly wheel and second fly wheel with the corresponding first driving wheel and second driving wheel are formed, along an outer circumference of each fly wheel, with non-continuous friction surfaces which are constituted by plural equidistant friction plates, with a groove being provided between neighboring friction plates.

9. The power generating apparatus according to claim 8, wherein each friction plate is freely loadable and unloadable on the outer circumference of the fly wheel to facilitate replacement after abrasion.

10. The power generating apparatus according to claim 2, wherein an arm of any one or both of the first fly wheel and the second fly wheel is provided with at least a pair of diametrically symmetric centrifugal weighting unit.

11. The power generating apparatus according to claim 2, wherein a downstream of the second fly wheel is further provided with a third fly wheel which is driven by an output shaft of the second fly wheel through a third transmission device and a third driving wheel, an output shaft of the third fly wheel is used to output power to do work and to feed back part of an output moment to the first driving wheel to drive the first fly wheel.
